(19) United States
(12) Patent Application Publication
(10) Pub. No.: US 2011/0031849 A1
(43) Pub. Date: Feb. 10, 2011

(54) ELECTRICITY-GENERATING APPARATUS FOR BICYCLE

(76) Inventor: Wen-Hsiung Hsueh, Changhua County (TW)

Correspondence Address: Chien-Hui Su, P. O. Box 70-121 Taichung, Taichung City, 40899, TW

(21) Appl. No.: 12/538,832

(22) Filed: Aug. 10, 2009

(51) Int. Cl. H02K 7/00

(52) U.S. Cl. 310/67 R

(57) ABSTRACT

An electricity-generating apparatus for bicycle includes a holder and an induction assembly. The holder is adapted to be connected to a bicycle fork. The induction assembly detachably screws to the holder. The induction assembly comprises an outer sleeve. The outer sleeve coaxially receives an insulating sleeve, an iron core and a rod. The insulating sleeve is wound by an induction coil electrically connected to the rod and the outer sleeve. At least one magnet is adapted to be engaged with the bicycle spokes for being adapted to induce a magnetic environment around the induction coil. Therefore, the induction assembly generates electricity.

### BACKGROUND OF THE INVENTION

1. Field of the Invention

The present invention relates to an electricity-generating apparatus for bicycle, and more particularly to an apparatus which generates electricity for a bicycle lighting device according to Faraday's Law of induction.

2. Description of Related Art

A conventional electricity-generating apparatus in accordance with the prior art comprises a wheel and a fixed conducting rod, both in electrical contact with the wheel and at least one electrical component in which the wheel is rotatable about an axis. The wheel comprises a rotatable hub and a rotatable conducting rod within the rotatable hub. At least one electricity-generating device is placed along the spoke and attached to the hub and comprises a generally hollow housing having a distal end, a proximate end, a wire coil fixed within the housing and having an axial bore therethrough, a translatable magnet, and at least one wire in electrical contact with the wire coil and the rotatable hub. Therefore, when the wheel is rotated, the translatable magnet laterally translates back and forth with the housing and passing through the wire coil to generate the electric current.

However, the prior art is suffered from several disadvantages. Due to the assembly, the electricity-generating apparatus is inconvenient to be detached from the wheel for maintenance or replacement when the electricity-generating apparatus is broken. Moreover, the wheel is heavy to rotate because each electricity-generating device is placed along a spoke.

The present invention has arisen to mitigate and/or obviate the disadvantages of the conventional electricity-generating apparatus.

### SUMMARY OF THE INVENTION

The main objective of the present invention is to provide an improved electricity-generating apparatus for bicycle.

To achieve the objective, the electricity-generating apparatus for bicycle in accordance with the present invention includes a holder and an induction assembly. The holder adapts to be connected to a bicycle fork adjacent bicycle spokes. The induction assembly detachably screwed to the holder for being easily replaced when the induction assembly is broken.

The induction assembly comprises an outer sleeve. The outer sleeve coaxially receives an insulating sleeve, an iron core and a rod. The insulating sleeve is wound by an induction coil which has a first end and a second end formed thereof. The first end and the second end electrically connected to the rod and the outer sleeve respectively. The rod and the outer sleeve are made of metal.

The iron core is received in the insulating sleeve and has an induction portion and a connecting portion extended from two ends thereof respectively. The induction portion of the iron core covers one end of the outer sleeve and faces toward the bicycle spokes. The connecting portion screwedly connects to one end of the rod. The other end of the rod is fixed to a cover. The cover sealingly covers the other end of the outer sleeve opposite to the end covered with the induction portion of the iron core.

The electricity-generating apparatus for bicycle further comprises at least one magnet adapted to be engaged with the bicycle spokes for being adapted to induce a magnetic environment around the induction coil. When the at least one magnet rotates with the bicycle spokes. The at least one magnet repeatedly rotates away from and toward the induction portion to be adapted to change the magnetic environment. Therefore, the induction coil is adapted to be produced an electromotive force therein.

In addition, the induction assembly screws away from or toward the at least one magnet, such that the electromotive force is adjusted.

Further benefits and advantages of the present invention will become apparent after a careful reading of the detailed description with appropriate reference to the accompanying drawings.

### BRIEF DESCRIPTION OF THE DRAWINGS

FIG. 1 is a perspective explosive view of an electricity-generating apparatus for bicycle of present invention;

FIG. 2 is an assembled plane view of the electricity-generating apparatus for bicycle of present invention as a user is riding the bicycle;

FIG. 3 is a partial enlarged perspective view of an induction assembly of the electricity-generating apparatus for bicycle of present invention in FIG. 2; and

FIG. 4-5 are operational views of the electricity-generating apparatus for bicycle of present invention.

### DETAILED DESCRIPTION OF THE INVENTION

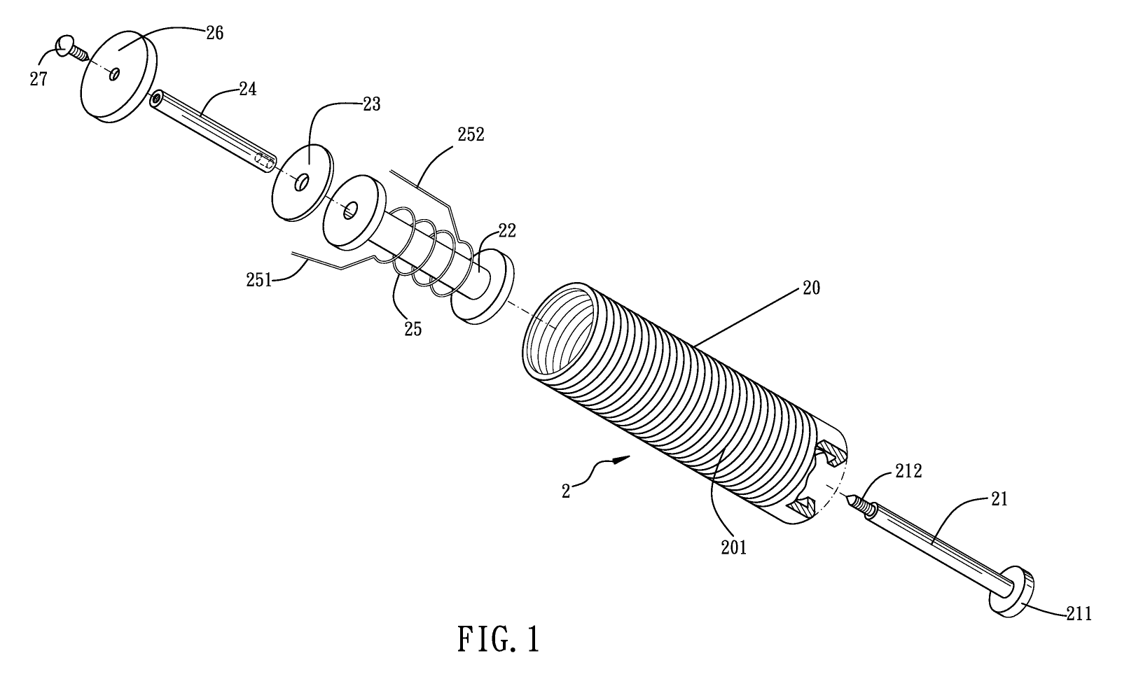

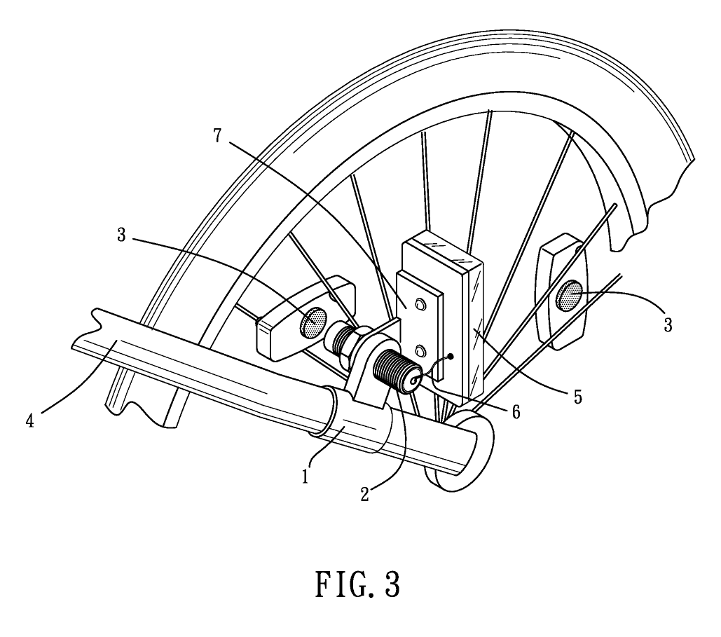

Referring to the drawings and initially to FIGS. 1-3, an electricity-generating apparatus for bicycle in accordance with a preferred embodiment of the present invention comprises a holder 1 and an induction assembly 2. The holder 1 is adapted to be connected to a bicycle fork 4 being adjacent to bicycle spokes (not numbered). The induction assembly 2 is detachably and adjustably screwed to the holder 1 for being easily replaced when the induction assembly 2 is broken.

The induction assembly 2 comprises an outer sleeve 20 having an outer threaded periphery 201 for screwedly and detachably connecting to the holder 1. The outer sleeve 20 is made of copper. The outer sleeve 20 coaxially receives an insulating sleeve 22, an iron core 21, a washer 23 and a rod 24. The insulating sleeve 22 is wound by an induction coil 25 which has a first end 251 and a second end 252 respectively extending therefrom. The first end 251 and the second end 252 electrically connected to the rod 24 and the outer sleeve 20 respectively. The rod 24 is made of metal.

The iron core 21 is received in the insulating sleeve 22. The iron core 21 has an induction portion 211 and a connecting portion 212 extended from two ends thereof respectively. The induction portion 211 of the iron core 21 covers one end of the outer sleeve 20 and faces toward the bicycle spokes when the holder 1 is mounted on the bicycle fork 4. The connecting portion 212 projects from one end of the insulating sleeve 22 and passes through the washer 23 to screw into one end of the rod 24. The washer 23 and the rod 24 are placed out of one end of the insulating sleeve 22. The other end of the rod 24 is fixed to a cover 26 with a fixing unit 27 made of metal. The cover 26 sealingly covers the other end of the outer sleeve 20 opposite to the end covered with the induction portion 211 of the iron core 21. In addition, the two ends of the outer sleeve 20 contacted with the cover 26 and the induction portion 211 respectively are insulated.

Moreover, the outer sleeve 20 is electrically connected to a support base 7 made of metal. The support base 7 is electrically connected to a lighting device 5 held thereby. The fixing unit 27 is electrically connected to the lighting device 5 by an electrical wire 6. Therefore, the induction assembly 2 is electrically connected to the lighting device 5.

The electricity-generating apparatus for bicycle further comprises at least one magnet 3 adapted to be engaged with the bicycle spokes in a face-to-face relation with the induction portion 211 for being adapted to induce a magnetic environment around the induction coil 25.

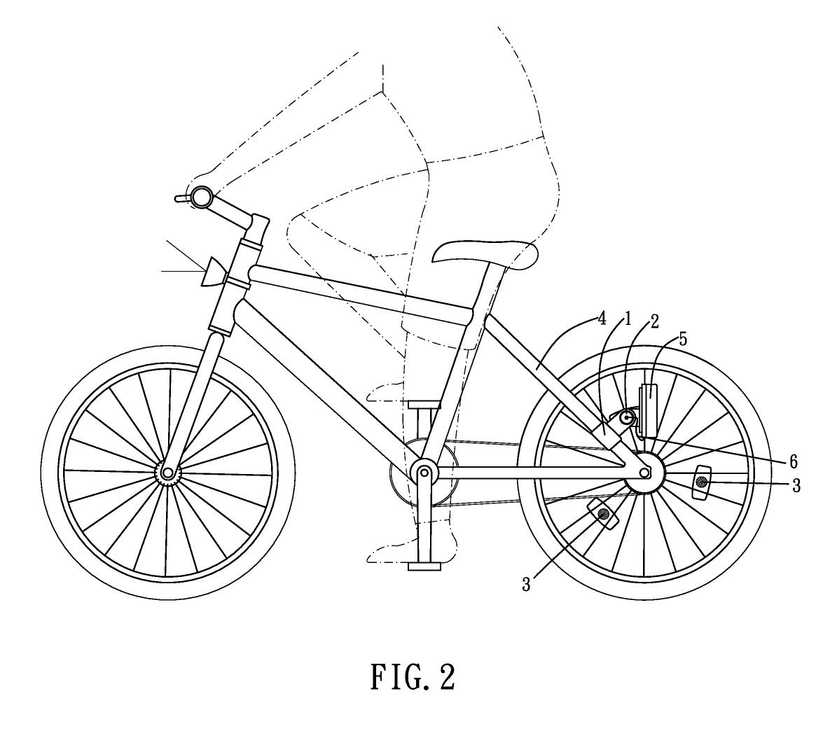

As shown in FIG. 2, when a user rides the bicycle, the at least one magnet 3 rotates with the bicycle spokes. The at least one magnet 3 repeatedly rotates away from and toward the induction portion 211 of the iron core 21 to be adapted to change the magnetic environment. According to the Faraday's Law of Induction, the induction coil 25 is adapted to be induced an electromotive force therein. Therefore, the induction assembly 2 generates electricity and provides electricity to the light device 5 for illuminating.

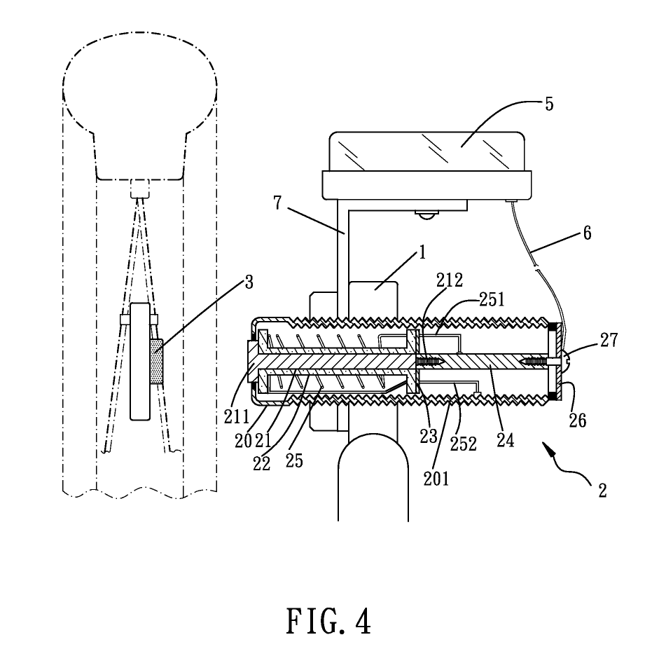

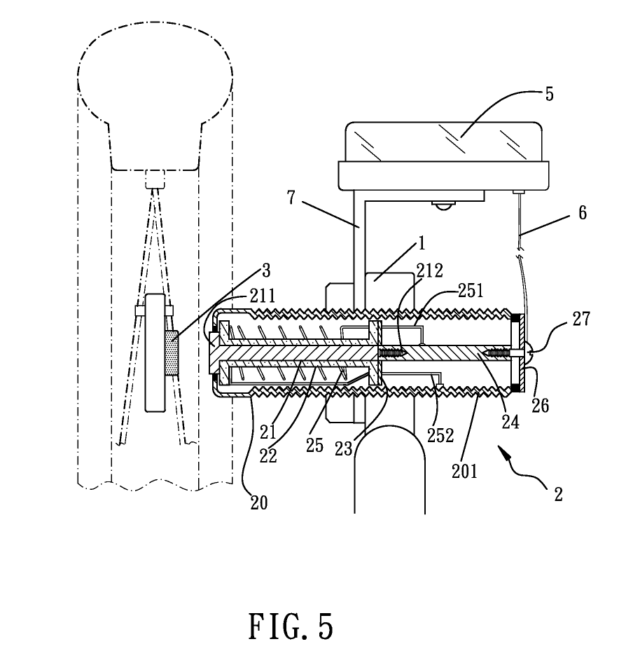

FIG. 4-5 shows that the induction assembly 2 connected to the holder 1 screws away from and toward the at least one magnet 3 respectively to be adapted to change a magnet field strength between the at least one magnet 3 and the induction assembly 2, such that the electromotive force is adjustable.

Although the invention has been explained in relation to its preferred embodiment, it is to be understood that many other possible modifications and variations can be made without departing from the spirit and scope of the invention as hereinafter claimed.

What is claimed is:

1. An electricity-generating apparatus for bicycle comprising:
a holder adapted to be connected to a bicycle fork;
an induction assembly detachably connected to the holder, the induction assembly comprising:
an outer sleeve detachably screwed to the holder;
an insulating sleeve coaxially received in the outer sleeve;
an induction coil wound around the insulating sleeve;
an iron core received in the insulating sleeve; and
a rod coaxially received in the outer sleeve and having one end connected to the iron core;
wherein the induction coil electrically connected to the rod and the outer sleeve; and
at least one magnet adapted to be engaged with the bicycle spokes for being adapted to create a magnetic environment around the induction coil;
wherein when the at least one magnet rotates with the bicycle spokes, the at least one magnet interacts with the induction assembly to be adapted to induce an electromotive force in the induction coil for generating electricity, the electromotive force being adjusted by screwing the induction assembly toward/away from the at least one magnet.

2. The electricity-generating apparatus for bicycle as claimed in claim 1, wherein the iron core has an induction portion and a connecting portion extended from two ends thereof respectively, the induction portion faced toward the at least one magnet for being adapted to create a magnetic field, the connecting portion projecting from the insulating sleeve and screwing into one end of the rod.

3. The electricity-generating apparatus for bicycle as claimed in claim 1, wherein the induction coil has a first end and a second end respectively extending therefrom, the first end electrically connected to the rod, the second end electrically connected to the outer sleeve.

4. The electricity-generating apparatus for bicycle as claimed in claim 1, wherein the induction assembly further comprises a cover sealingly covering one end of the outer sleeve, the cover connected to the other end of the rod opposite to the end connected to the iron core.
